(19) United States
(12) Patent Application Publication
(10) Pub. No.: US 2003/0185520 A1
(43) Pub. Date: Oct. 2, 2003

(54) Device and method for coupling optical fibers

(76) Inventors: Dana C. Bookbinder, Corning, NY (US); Michael E. DeRosa, Painted Post, NY (US)

Correspondence Address: CORNING INCORPORATED, SP-TI-3-1, CORNING, NY, 14831

(21) Appl. No.: 10/107,290

(22) Filed: Mar. 26, 2002

(51) Int. Cl. G02B 6/38; G02B 6/40

(52) U.S. Cl. 385/73; 385/58; 385/54

(57) ABSTRACT

A method of mating optical fibers includes the steps of coupling a first end portion of a first optical fiber to a first connector, coupling a second end portion of a second optical fiber to a second connector, disposing fluid between the first end portion and the second end portion, and placing an end surface of the first end portion and an end surface of the second end portion into contact with each other at a contact point, to thereby cause the fluid to flow away from the contact point.

### FIELD OF THE INVENTION

The invention relates generally to coupling optical fibers and more specifically, the invention relates to coupling optical fibers in a reliable manner by avoiding damage to ends of the fibers during coupling.

### BACKGROUND OF THE INVENTION

It is well known to utilize optical amplifiers and optical fibers for communications and other applications. Typical optical communications amplifiers launch signals of about 200 mW. Next generation amplifiers are already being developed with signals in the 500 mW range. Higher power signals will permit greater bandwidth in Dense Wavelength Division Multiplexing (DWDM) systems and in other applications. Higher signal power also reduces the need for repeaters and thus reduces the complexity and cost of a total system.

Of course, in optical communications systems and other applications, it is often necessary to connect, i.e. splice, optical fibers to one another. There are two primary methods used for splicing optical fibers. In a fusion splice, the connection is accomplished by the application of localized heat sufficient to fuse or melt the ends of two lengths of optical fiber, forming a continuous single fiber. In a connector splice, two mating pieces of hardware, i.e. connectors, are mechanically coupled to ends of the respective fibers to be spliced and the connectors are mated to one another to position the ends of the fibers in opposition to one another. Fusion splicing generally is the more reliable method but connector splicing provides greater convenience and flexibility since the splices can be undone and redone easily.

One application requiring high optical power is a technology known as Distributed Raman Assisted Transmission (DRAT) amplifiers which use 1420 nm to 1480 nm optical pumps to create a gain in a transmission fiber due to the “Raman effect.” When light is transmitted through the fiber, part of the light is scattered in random directions. A small part of the scattered light has frequencies removed from the frequency of the communications beam by quantities equal to vibration frequencies of the fiber core material. This phenomenon is known as “Raman scattering.” Assuming the communications beam is sufficiently intense and monochromatic, a threshold can be reached beyond which light at the Raman frequencies is amplified, builds up strongly, and generally exhibits the characteristics of stimulated emission known as the Raman effect. In such high power optical systems, it is very important to have efficient connections between fibers to avoid power loss and/or damage to the optical fibers

### SUMMARY OF THE INVENTION

According to one embodiment of the present invention a method of mating optical fibers includes the steps of coupling a first end portion of a first optical fiber to a first connector, coupling a second end portion of a second optical fiber to a second connector, disposing fluid between the first end portion and the second end portion, and placing an end surface of the first end portion and an end surface of the second end portion into contact with each other at a contact point, to thereby cause the fluid to flow away from the contact point.

According to an embodiment of the present invention an optical device includes: (i) a first optical fiber having a first end portion coupled to a first connector; (ii) a second optical fiber having a second end portion coupled to a second connector, said second portion of said second optical fiber at least partially contacting said first portion of said first optical fiber; and (iii) a channel for guiding fluid located proximate to said first and second portions away from said first and second portions.

According to another embodiment of the present invention the optical device includes: (i) a first plurality of optical fibers each having a first end portion coupled to a first connector; (ii) a second plurality of optical fibers each having a second end portion coupled to a second connector, said second portions of said second plurality of optical fibers at least partially contacting said first portions of said first plurality of optical fibers; and (iii) at least one channel for guiding fluid located proximate to said first and second portions away from said and second portions.

### BRIEF DESCRIPTION OF THE DRAWING

The invention is described through a preferred embodiment and the attached drawing in which:

FIG. 1 is a side view, in partial section, of optical fiber connectors in a sleeve Just prior to being coupled in accordance with one embodiment;

FIG. 2 is a detailed side view of optical fibers in the connectors of FIG. 1 after the connectors are coupled in accordance with one embodiment; and

FIG. 3 is a graph of test results comparing a connection made in accordance with the preferred embodiment and a conventional connection.

FIG. 4 is a side view of optical fiber connectors in a sleeve, just prior to being coupled, in accordance with another embodiment.

FIG. 5 is a side view of the optical connectors of FIG. 4, after the connectors are coupled.

FIG. 6 is a side view of optical fiber connectors in a sleeve, just prior to being coupled, in accordance with another embodiment.

FIG. 7 is a side view of the optical connectors of FIG. 6, after the connectors are coupled.

### DETAILED DESCRIPTION

Applicant found that a primary cause of optical failure in high power application connections is due to contaminating particles on the ends of the fibers. Such particles can absorb energy and create intense localized hot regions or, in the case of organic particles, can carbonize due to thermal runaway at the fiber interface. This causes damage to end faces of the fibers being connected. Further, such particles can act as lenses and focus the light to an intensity that can damage the fiber and create a high Insertion Loss (IL).

Of course, it is possible to manufacture contamination free connectors. However, it is difficult, if not impossible, to maintain the contamination free state when making connections of optical fibers in the field. Rigorous and redundant cleaning techniques are helpful in eliminating contaminating particles. However, particles still can get into the connection after cleaning in the field. Further, known cleaning techniques often themselves introduce contaminants into the connection. For example, wipes can introduce residual fibers into the connection and unfiltered cleaning solutions, such as isopropanol, can introduce particles.

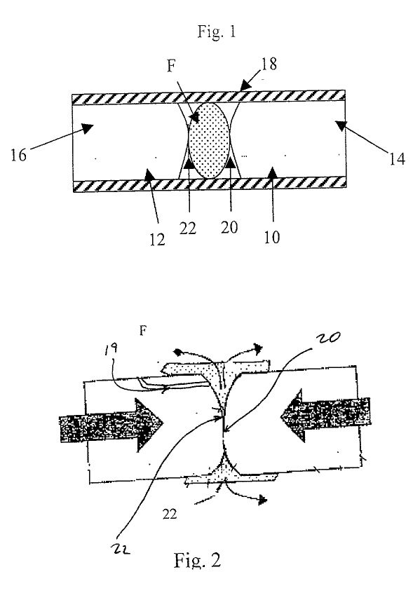

The preferred embodiment is a method of making a connection between optical fibers in which contaminating particles are forced out of the connection while the connection is being made. The preferred embodiment uses a “saturated” connector mating procedure. FIGS. 1 and 2 illustrate a connection being made in accordance with the preferred embodiment. As illustrated in FIG. 1, first connector 10 is coupled to an end of first optical fiber 14 in a conventional manner. Second connector 12 is coupled to an end of second optical fiber 16, to be coupled with first optical fiber 14, also in a conventional manner. First connector 10 and second connector 12 can be any type of connectors formed to mate with one another in any manner. For example, first connector 10 and second connector 12 can define a bayonet connection, a screw thread connection, a pressure fit connection, or the like, and such connecting elements are not illustrated in detail in FIG. 1. Sleeve 18 (shown in cross section), made of ceramic or other material, can be fitted over first connector 10 and second connector 12 to facilitate alignment during mating.

Prior to mating first connector 10 and second connector 12, an amount of fluid F, a drop in the preferred embodiment, is placed in a space (reservoir) between connecting end portions 20 and 22 of first optical fiber 14 and second optical fiber 16 respectively. Fluid F can be introduced into the space through an opening formed in sleeve 18, through an opening formed in first connector 10 or second connector 12, prior to placing one or both of connectors 10 and 12 in sleeve 18, or in any other manner.

Any type of fluid F can be used and fluid F can be of any type. Preferably, fluid F is a solvent to cause contaminating particles on connecting end portions 20 and 22 to become suspended therein. Any volume of fluid can be used. Applicant has found the range of 0.01 to 1.0 ml, inclusive, to be effective. Further, Applicant has found that it is preferable to use a fluid having a relatively low boiling point. For example, the boiling point is preferably less than 300 C, more preferably less than 200 C and most preferably less than 110 C. By using a fluid with a low boiling point, and mating the end portions in the method described, it will allow the fluid to clean the surfaces of the fiber by suspending particles that were in the lightpath, allowing them to be moved out of the lightpath during the mating procedure, and allowing the fluid to evaporate from the interface and light path. By letting the fluid escape (via a channel provided for that purpose) and evaporate, there will be little or no absorption of the light and damage at the end portion will not occur. The channel may be in a form of a cavity 19 in a body of one or both connectors, or it maybe formed by facing connector surfaces as shown for example in FIG. 2. Also, evaporation of the fluid minimizes the possibility of igniting the fluid, which can damage the end portions of the fibers. However, depending on the boiling point of the fluid and other factors, there may be some fluid present during communication using the fibers. In such instances, it can also be helpful if the fluid has a low absorption at the desired wavelength. Specifically if the connection is to be used in the Raman pump wavelength (1420-1480 nm), the fluid should have low absorption in the 1420-1480 nm band. Also, ignition of the fluid can be minimized by mixing any flammable fluids with water to create an aqueous solution of preferably 5% to 95% water. However, other percentages of water can be used depending on the other constituents of the fluid. Further, the possibility of ignition can be reduced by coupling the fibers together while energy transmitted through either fiber is 1 mW or less.

In the preferred embodiment, particles are removed from ends of the fibers by placing fluid between the ends and pressing the ends into contact with one another. The invention can be used with any type of connector, such as PC (Physical Contact) connectors or APC (Angled Physical Contact) connectors. The invention is simple to implement, is inexpensive, and can be used in connection with conventional connectors. The invention can be used in combination with conventional connecting and cleaning procedures. Various types of fluid can be used. However, it may be desirable to use a fluid having a high wettability with respect to the material of the fiber, e.g. glass. In particular, it is desirable for the fluid to be selected to wet the surface of the fiber with a contact angle of about 70 degrees or less. For example, various fluids can be used such as methanol, isopropanol, and ethanol, or other highly polar solvents. Also, aqueous solutions of these compositions can be used as the fluid. The fluid can be chosen to be relatively volatile to facilitate evaporation of the fluid after coupling. The fluid can be allowed to escape the connectors through an opening or can retreat into cavities defined by the connectors. The fluid can be selected to have an index of refraction that matches that of the fiber to minimize back reflection.

Exemplary fluids include, without limitation, (i) water; (ii) alcohols (ROH, where R is hydrocarbon or ether hydrocarbon) such as isopropanol, ethanol, butoxy ethanol, etc.; (iii) diols or triols (R(OH)ₙ where R is a hydrocarbon) such as ethylene glycol. glycerine, cellosolves and derivatives thereof, etc.; (iv) a keto-functional solvent (R¹COR² where R¹ and R² are hydrocarbons) such as acetone, methylisobutyl ketone, etc.; (v) esters (R¹COOR² where R₁ and R₂ are hydrocarbons) such as methyl acetate, ethyl acetate, ethyl benzoate, methyl benzoate, etc.; (vi) alcohol esters (R¹COOR²OH where R¹ is a hydrocarbon and R² is a hydrocarbon or an ether hydrocarbon) such as 2-ethoxy-acetate ethanol; (vii) saturated aliphatic hydrocarbons such as hexane, cyclohexane, etc.; (viii) aromatic hydrocarbons such as benzene, xylene, toluene, etc.; (ix) solutions which include one or more non-ionic, cationic, anionic, and/or zwitterionic surfactants; and (x) ammonia solutions. In addition, the fluid can be a combination of any one or more of the above-listed exemplary fluids. The fluid can also be a halogenated derivative of an alcohol, diol, triol, keto-functional solvent, ester, or alcohol ester.

With fluid F in the space, first connector 10 and second connector 12 are caused to mate, by pressing them towards one another for example. The mating action of first connector 10 and second connector 12 causes connecting end portions 20 and 22 to move towards one another, in the direction indicated by the large arrows in FIG. 2, until connection end portions 20 and 22 abut one another, as illustrated in FIG. 2. As indicated by the small arrows in FIG. 2, the movement of connecting end portions 20 and 22 towards one another forces fluid F out the space between connecting end portions 20 and 22 and thus also forces the suspended contaminated particles out of the space thus providing a clean environment in which connecting end portions 20 and 22 can abut one another without contaminating particles therebetween.

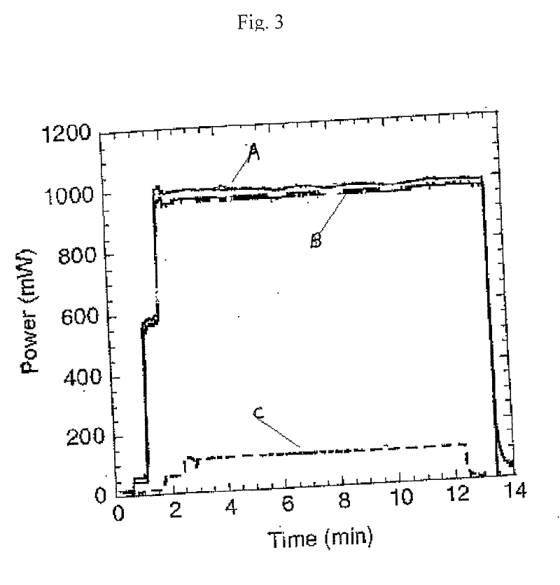

FIG. 3 illustrates the results of a comparative test between a connection made in accordance with the preferred embodiment and a conventional connection. In this test, 0.5% by weight of carbon black, as contaminating particles, was suspended in a fluid of a low viscosity of an acrylate monomer. Carbon black was selected because it is a broadband absorbing impurity that has a high absorption coefficient at near infrared wavelengths. The concentration in this test is orders of magnitude higher than is likely to be experienced in the field in order to demonstrate the effectiveness of the preferred embodiment. A PC connector having an optical fiber end secured therein was slid in to a ceramic sleeve. One drop of the carbon black solution was placed in the sleeve to contaminate the end of the optical fiber. A mating connector having an end of an optical fiber was then fitted into the sleeve and caused to mate with the other connector while abutting ends of the optical fibers against one another. The connected fibers were then fusion spliced into a high power CW fiber laser setup and exposed to 1 W of power at 1550 nm for a period of over 13 minutes and power coming out of the fiber in which the connection was made was measured. This test procedure was repeated 5 times with similar results. Curve B of FIG. 3 illustrates the light power after passing through the connection versus time of one test that is exemplary of all tests. Curve A illustrates the incident light power versus time. It can be seen that the loss through the connection is about 0.11 dB, i.e. is very low. Inspection to the ends of the fibers after exposure indicated no damage to the ends of the fiber endfaces.

For comparison, another connector pair was prepared and contaminated in a similar manner. However, a gap was left between the connecting ends of the optical fibers to permit contaminant to remain between the connecting ends. This connection was spliced into a laser system and exposed to the same light at the same power as the test connections above. The resulting light passing through the connection is illustrated by curve C in FIG. 3. Clearly, the attenuation of light passing through the comparison connection is very high as compared to the test connections. In fact, losses in the comparison connection were about 9.5 dB. Inspection of the ends of the fibers in the comparison connection indicated severe damage to the ends of the fibers.

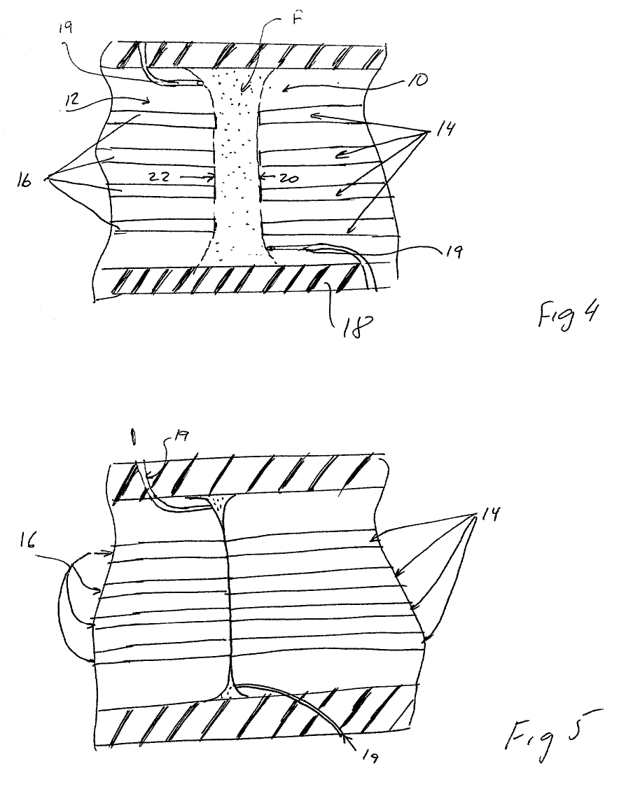

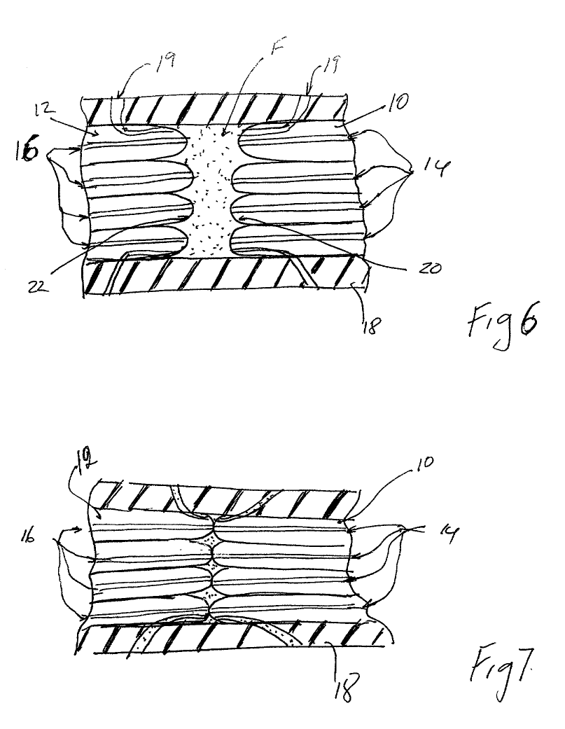

It is noted that multiple pairs of fibers 14, 16 may be connected in the manner discussed above. That is, a plurality of fibers maybe included within each connector, the fluid would be placed between the facing portions of each connector, (FIGS. 4, 6) the fiber pairs would then be placed in contact with one another (FIGS. 5, 7), displacing the liquid away from contact points. It is noted that each connector may include a plurality of sub-connectors, as shown, for example in FIGS. 6 and 7. Each of the two connectors or sub-connectors may be a mating portion of either a PC or a APC connector.

The invention has been described through disclosed embodiments. However, various modifications can be made without departing from the scope of the invention as defined by the appended claims and legal equivalents thereof.

### Parts List

10 connector

12 connector

14 fiber

16 fiber

18 sleeve

20 end surface

22 end surface

F fluid

What is claimed is:

1. A method of mating optical fibers comprising the steps of:
coupling a first end portion of a first optical fiber to a first connector;
coupling a second end portion of a second optical fiber to a second connector;
disposing fluid between an end surface of the first end portion and an end surface of the second end portion; and
placing the end surface of the first end portion and the end surface of the second end portion into contact with each other at a contact point to thereby cause the fluid to flow away from the contact point.

2. The method as recited in claim 1, further comprising the step of cleaning the end surface of the first end portion and the end surface of the second end portion prior to said placing step.

3. The method as recited in claim 1, wherein at least one of said first connector and said second connector have an opening formed therein and the liquid flows out of the opening during said placing step.

4. The method as recited in claim 1, wherein said disposing step comprises disposing the fluid on at least one of an end surface of the first end portion and an end surface of the second end portion.

5. The method as recited in claim 1, wherein the fluid comprises water.

6. The method as recited in claim 1, wherein the fluid comprises an alcohol.

7. The method as recited in claim 6, wherein the fluid further comprises water

8. The method as recited in claim 7, wherein the percentage of water in the fluid in the range of 5% to 95%, inclusive.

9. The method as recited in claim 1, wherein the fluid comprises a diol.

10. The method as recited in claim 9, wherein the fluid further comprises water

11. The method as recited in claim 10, wherein the percentage of water in the fluid in the range of 5% to 95%, inclusive.

12. The method as recited in claim 1, wherein the fluid comprises a triol.

13. The method as recited in claim 12, wherein the fluid further comprises water

14. The method as recited in claim 13, wherein the percentage of water in the fluid in the range of 5% to 95%, inclusive.

15. The method as recited in claim 1, wherein the fluid comprises a keto-functional solvent.

16. The method as recited in claim 15, wherein the fluid further comprises water

17. The method as recited in claim 16, wherein the percentage of water in the fluid in the range of 5% to 95%, inclusive.

18. The method as recited in claim 1, wherein the fluid comprises an ester.

19. The method as recited in claim 18, wherein the fluid further comprises water

20. The method as recited in claim 19, wherein the percentage of water in the fluid in the range of 5% to 95%, inclusive.

21. The method as recited in claim 1, wherein the fluid comprises an alcohol ester.

22. The method as recited in claim 21, wherein the fluid further comprises water

23. The method as recited in claim 22, wherein the percentage of water in the fluid in the range of 5% to 95%, inclusive.

24. The method as recited in claim 1, wherein the fluid comprises a aliphatic hydrocarbon.

25. A method according to claim 24, wherein said aliphatic hydrocarbon is a saturated aliphatic hydrocarbon.

26. The method as recited in claim 1, wherein the fluid comprises an aromatic hydrocarbon.

27. The method as recited in claim 1, wherein the fluid comprises a surfactant.

28. The method as recited in claim 27, wherein the fluid further comprises water.

29. The method as recited in claim 28, wherein the percentage of water in the fluid in the range of 5% to 95%, inclusive.

30. The method as recited in claim 1, wherein the fluid comprises ammonia.

31. The method as recited in claim 30, wherein the fluid further comprises water

32. The method as recited in claim 32, wherein the percentage of water in the fluid in the range of 5% to 95%, inclusive.

33. The method as recited in claim 1, further comprising the step of matching the refractive index of the liquid with a refractive index of the first optical fiber and the second optical fiber prior to said disposing step.

34. The method as recited in claim 1, wherein the first connector and the second connector are each a mating portion of a PC connector.

35. The method as recited in claim 1, wherein the first connector and the second connector are each a mating portion of an APC connector.

36. The method as recited in claim 1, wherein said disposing step comprises disposing the liquid on at least one of an end surface of the first end portion and an end surface of the second end portion.

37. The method as recited in claim 1, wherein said disposing step comprises disposing between 0.01 and 1.0 ml, inclusive, of fluid between an end surface of the first end portion and an end surface of the second end portion.

38. The method as recited in claim 1, wherein the first optical fiber and the second optical fiber are made of glass.

39. The method as recited in claim 1, wherein said placing step comprises mating the first connector with the second connector.

40. The method as recited in claim 1, further comprising the step of selecting the fluid, the first optical fiber, and the second optical fiber so that the fluid wets the end surfaces with a contact angle of 70 degrees or less.

41. The method as recited in claim 1, further comprising the step of evaporating the fluid.

42. The method as recited in claim 41, further comprising the step of limiting energy transmitted through the optical fibers to 1 mW or less until the evaporating step is finished.

43. An optical device comprising:
(i) a first optical fiber having a first end portion coupled to a first connector;
(ii) a second optical fiber having a second end portion coupled to a second connector said second portion of said second optical fiber at least partially contacting said first portion of said first optical fiber; and
(iii) a channel for guiding a fluid located proximate to said first and second portions away from said first and second portions.

44. The optical device according to claim 43, wherein said first and second connectors are each a matching portion of a PC connector.

45. The optical device according to claim 43, wherein said first and second connectors are each a matching portion of a APC connector.

46. The optical device comprising:
(i) a first plurality of optical fibers each having a first end portion coupled to a first connector;
(ii) a second plurality of optical fibers each having a second end portion coupled to a second connector, said second portions of said second plurality of optical fibers at least partially contacting said first portions of said first plurality of optical fibers; and
(iii) at least one channel for guiding fluid located proximate to said first and second portions away from said and second portions.

47. The optical device according to claim 46, wherein said first and second connectors are each a matching portion of a PC connector.

48. The optical device according to claim 46, wherein said first and second connectors are each a matching portion of an APC connector.

49. The optical device according to claim 46, wherein each of said said first and second connectors includes a plurality of sub-connector pairs.

50. The optical device according to claim 49, wherein each said subconnector pairs are matching portions of a PC connector.

51. The optical device according to claim 49, wherein each said subconnector pairs are matching portions of an APC connector.
